(19) United States
(12) Patent Application Publication
(10) Pub. No.: US 2020/0236568 A1
(43) Pub. Date: Jul. 23, 2020

(54) MEASUREMENT CONFIGURATION METHOD AND SYSTEM FOR TERMINAL HAVING MULTI-RADIO-FREQUENCY RECEPTION CAPABILITY, AND TERMINAL

(71) Applicant: GUANGDONG OPPO MOBILE TELECOMMUNICATIONS CORP., LTD., Dongguan (CN)

(72) Inventors: NING YANG, Dongguan (CN); Jianhua Liu, Dongguan (CN); Zhi Zhang, Dongguan (CN)

(21) Appl. No.: 16/838,998

(22) Filed: Apr. 2, 2020

Related U.S. Application Data
(63) Continuation of application No. PCT/CN2017/106603, filed on Oct. 17, 2017.

(51) Int. Cl. H04W 24/08

(52) U.S. Cl. CPC H04W 24/08

(57) ABSTRACT

Provided are a measurement configuration method and system for a terminal with a multi-Radio Frequency (RF) receiving capability and the terminal. Therefore, in a multi-RF-chain scenario, throughput performance of a terminal is ensured as much as possible on the premise of ensuring measurement accuracy. In the application, the terminal is connected with a first network node in a first wireless network through a first RF chain; the terminal is connected with a second network node in a second wireless network through a second RF chain; the first network node sends measurement object information to the second network node; the second network node generates measurement configuration information according to the measurement object information; the terminal acquires the measurement configuration information; the terminal implements RF measurement by the second RF chain according to the measurement configuration information; and the first network node acquires a measurement result of the terminal.

### CROSS-REFERENCE TO RELATED APPLICATION

This application is a continuation of international application PCT/CN2017/106603 filed on Oct. 17, 2017, the content of which is hereby incorporated by reference in its entirety.

### TECHNICAL FIELD

The application relates to the field of wireless communications, and more particularly, to a technology of measurement configuration of a terminal.

### BACKGROUND

In a conventional wireless communication system (for example, Global System for Mobile communication (GSM)/Wideband Code Division Multiple Access (WCDMA)/Long Term Evolution (LTE)), a hypothesis is usually made on a network side that one transmitting and receiving Radio Frequency (RF) chain is adopted for a terminal, that is, the terminal, when receiving data from a network (for example, LTE) or at a frequency point (for example, 1.9 GHz), cannot receive data from another network (for example, WCDMA) or at another frequency point (for example, 2.6 GHz). Under this condition, the network needs to configure a measurement gap for the terminal. In such a case, data cannot be transmitted from the network or at the frequency point originally serving the terminal, and the terminal needs to retune the RF chain to a corresponding frequency for measurement and then retune the RF chain back to the original frequency point at the end of the measurement gap to continue reception of downlink data.

According to the above method, downlink data transmission on an original chain is interrupted during RF chain retuning, and consequently, a throughput of a user may be greatly influenced.

Support to multiple RF chains has been gradually considered to be introduced to a future communication system. For example, under an LTE dual connectivity condition, a terminal considers to simultaneously receive and send data on two chains. In an LTE-New Radio (NR) multi-connection scenario and a NR-NR multi-connection scenario supported in a future NR network, a terminal may also simultaneously receive and send data on two chains. This is mainly because frequencies of two access points are greatly different in the LTE-NR or NR-NR scenario, which makes it impossible for them to share an RF chain, for example, LTE works at 2.6 GHz while NR works at a band such as 4.8 GHz or even higher 28 Hz or 38 GHz.

In a multi-RF-chain scenario, how to ensure throughput performance of a terminal as much as possible on the premise of ensuring measurement accuracy becomes a problem to be solved.

### SUMMARY

A first aspect of the embodiments provides a measurement configuration method which includes:

sending, by a first network node, information of a measurement object to a second network node, wherein the information of the measurement object is used for the second network node to generate part of measurement configuration information, the first network node is a master node, and the second network node is a secondary node; and

receiving, by the first network node, a measurement result obtained at the measurement object based on the measurement configuration information from a terminal with a multi-Radio Frequency (RF) receiving capability.

A second aspect of the embodiments provides a measurement configuration method, including:

acquiring, by a terminal with a multi-Radio Frequency (RF) receiving capability, measurement configuration information, part of the measurement configuration information being generated by a second network node;

implementing, by the terminal, RF measurement at a measurement object provided by a first network node according to the measurement configuration information; and

reporting, by the terminal, a measurement result to the first network node.

A third aspect of the embodiments provides a terminal including:

a transceiver, and

a processor, which is coupled with the transceiver and configured to control the transceiver to send and receive information;

wherein the terminal has a multi-Radio Frequency (RF) receiving capability, and the processor is configured to:

control the transceiver to acquire measurement configuration information, part of the measurement configuration information being generated by a second network node;

implement Radio Frequency (RF) measurement at a measurement object provided by a first network node according to the measurement configuration information; and

control the transceiver to report a measurement result to the first network node.

The application may have the advantages that, for a terminal with a multi-RF capability, particularly a multi-RF receiving capability, throughput performance of the terminal can be ensured as much as possible on the premise of ensuring measurement accuracy.

Numerous technical characteristics are described in the specification of the application and distributed in each technical solution. If all possible combinations (i.e., technical solutions) of the technical characteristics of the application are listed, the specification may be tedious. Therefore, each technical characteristic described in SUMMARY of the application, each technical characteristic described in each of the following implementation modes and examples as well as each technical characteristic described in the drawings can be freely combined to form various new technical solutions (all these technical solutions shall be considered to have been recorded in the specification) unless such combinations of the technical characteristics are technically impossible. For example, if characteristics A+B+C are described in an example, characteristics A+B+D+E are described in another example, the characteristics C and D are equivalent technical means playing the same role, which can be alternatively used technically and cannot be simultaneously used, and the characteristic E can technically be combined with the characteristic C, then a solution A+B+C+D is technically impossible and shall not be considered to have been recorded and a solution A+B+C+E shall be considered to have been recorded.

### BRIEF DESCRIPTION OF DRAWINGS

FIG. 1 is a schematic diagram of an LTE-NR multi-connection scenario according to the disclosure.

FIG. 2 is a flowchart of a measurement configuration method for a terminal with a multi-RF receiving capability according to a first implementation mode of the disclosure.

FIG. 3 is a flowchart of an example according to the first implementation mode of the disclosure.

### DETAILED DESCRIPTION

In the following descriptions, many technical details are proposed to make a reader understand the application better. However, those of ordinary skill in the art should know that the technical solutions claimed by the application can also be implemented even without these technical details or various variations and modifications made based on each of the following implementation modes.

Descriptions about concepts:

LTE: long term evolution;

NR: a radio access part in 5th-Generation (5G) and an abbreviation of new radio;

MN: master node;

SN: second node;

Measurement GAP: measurement gap;

GSM: global system for mobile communication;

WCDMA: wideband code division multiple access; and

Terminal: also called User Equipment (UE), a wireless terminal, a mobile terminal and a mobile station, etc.

Part of innovation points of the application will be briefly described below.

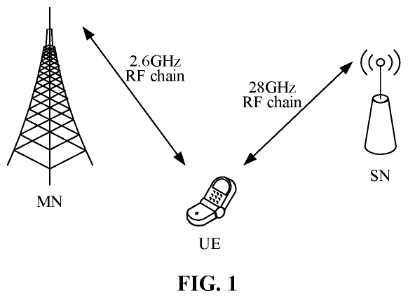

A terminal with a multi-RF capability may establish multiple RF chains with network nodes in multiple wireless networks simultaneously. For example, the terminal may be connected with a first network node in a first wireless network through a first RF chain and may be simultaneously connected with a second network node in a second wireless network through a second RF chain. In a case that the first network node is required to measure a measurement object, for example, a frequency point, a band or a band group, covered by the second RF chain, the first network node may send a measurement request message containing information of the measurement object to the second network node; the second network node, after receiving the measurement request message, may determine whether to accept the measurement request or not and, if the second network node determines to accept the measurement request, the second network node may generate measurement configuration information, and send the measurement configuration information directly to the terminal through the second RF chain or forward the measurement configuration information to the terminal by the first network node through the first RF chain. The terminal, after completing RF measurement on the second RF chain according to the measurement configuration information, may send an RF measurement result directly to the first network node through the first RF chain or forward the RF measurement result to the first network node through the second RF chain and the second network node. Since no measurement gap is set for the first RF chain in the whole measurement process, throughput performance of the first RF chain can be ensured. In addition, since the measurement configuration information is generated by the second network node (the first network node only provides a measurement object but does not generate measurement configuration information) and RF measurement is implemented on the second RF chain, the measurement object can be completely covered by the second RF chain, and the measurement accuracy can be ensured. A preferred application scenario of the technical solution is an LTE-NR multi-connection scenario. Due to limitations of LTE and NR bands, it is impossible to adopt a RF chain of LTE or NR to measure another chain. Therefore, when a network on one side needs to know signal quality of a network on the other side, coordination between the two networks can be implemented by use of the above technical solution, and an RF chain of the network on the other side can be adopted for measurement to solve a problem about measurement between different frequencies. In an application scenario, as shown in FIG. 1, UE is connected with a network node MN in an LTE network through a 2.6 GHz RF chain, the UE is simultaneously connected with a network node SN in an NR network through a 28 GHz RF chain, and if the SN needs to know an RF measurement result of the MN or the MN needs to know an RF measurement result of the SN, the above technical solution may be adopted.

Although the above described is a scenario involving two RF chains, the technical solution definitely can be applied to a scenario involving multiple RF chains. A network node, when needing to measure measurement objects in N other wireless networks, may send measurement request messages containing information of the measurement objects to network nodes in the N other wireless networks respectively, namely N measurement request messages are sent to N network nodes respectively, the N network nodes may generate measurement configuration information according to the information of the measurement objects respectively and directly or indirectly send the measurement configuration information to a terminal, and the terminal may perform RF measurement on N RF chains according to the N pieces of measurement configuration information respectively and directly or indirectly report N RF measurement results to the network node that initially sent the measurement request messages. Optionally, the N RF measurement results, after being summarized, may be reported to a network side by a certain RF chain in a unified manner.

In order to make the purpose, technical solutions and advantages of the application clearer, the implementation modes of the application will be further described below in combination with the drawings in detail.

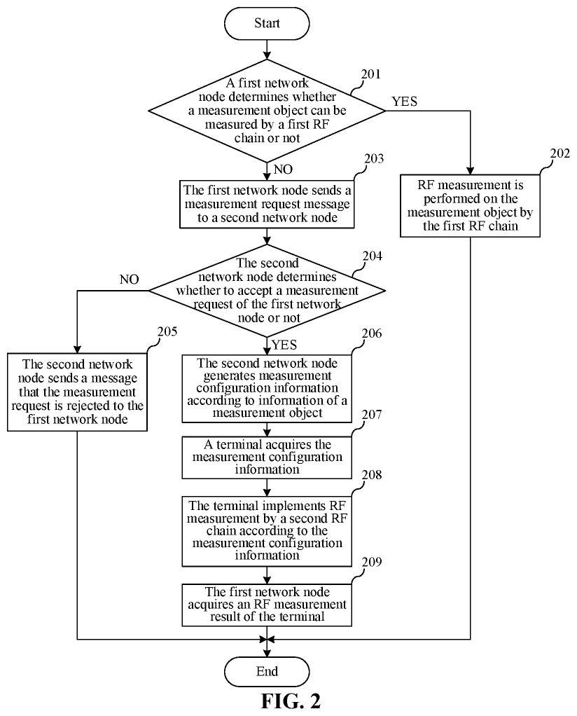

A first implementation mode of the disclosure relates to a measurement configuration method for a terminal with a multi-RF receiving capability. FIG. 2 is a flowchart of the measurement configuration method for a terminal with a multi-RF receiving capability. According to the measurement configuration method for a terminal with a multi-RF receiving capability, the terminal is connected with a first network node in a first wireless network through a first RF chain, and the terminal is also connected with a second network node in a second wireless network through a second RF chain. Optionally, the first wireless network is an LTE network, and the second wireless network is an NR network. Optionally, the first wireless network is an NR network, and the second wireless network is an LTE network. Optionally, both the first and second wireless networks are NR networks. Optionally, the first wireless network and the second wireless network may be two independent networks. Optionally, the first wireless network and the second wireless network may be the same network.

The method may include the following steps.

In step 201, the first network node determines whether a measurement object can be measured by the first RF chain or not; if not, step 203 is executed, otherwise step 202 is executed. In each implementation mode of the application, the measurement object may be a frequency point, a band or a band group, measurement information, measurement configuration information and the like. Optionally, the measurement object may be out of a band range supported by the first RF chain and within a band range supported by the second RF chain. Optionally, the measurement object may also be within the band range supported by the first RF chain, but the first RF chain cannot be used for measurement for ensuring throughput of the first RF chain, etc.

In step 202, RF measurement is performed on the measurement object by the first RF chain, and then the flow is ended.

In step 203, the first network node sends a measurement request message to the second network node, the measurement request message including information of a measurement object.

Then, step 204 is executed, namely the second network node, after receiving the measurement request message, may determine whether to accept a measurement request of the first network node or not; if the second network node does not accept the measurement request, step 205 is executed, and if the second network node accepts the measurement request, step 206 is executed.

In step 205, the second network node sends a message that the measurement request is rejected to the first network node, and then the flow is ended.

In step 206, the second network node generates measurement configuration information according to the information of the measurement object. The measurement configuration information may include information such as measurement gap information and a correspondence between a measurement gap and a measurement object.

Then, step 207 is executed, namely the terminal acquires the measurement configuration information. Optionally, the second network node may send the measurement configuration information to the terminal through the second RF chain. Optionally, the second network node may send the measurement configuration information to the first network node, and the first network node may send the measurement configuration information to the terminal through the first RF chain.

Then, step 208 is executed, namely the terminal implements RF measurement by the second RF chain according to the measurement configuration information to obtain an RF measurement result. Optionally, the RF measurement result may include information of the measured frequency point, the measured band or the measured band group and/or a corresponding measurement result.

Then, step 209 is executed, namely the first network node acquires the RF measurement result of the terminal. Optionally, the terminal may send the RF measurement result to the first network node through the first RF chain. Optionally, the terminal may send the RF measurement result to the second network node through the second RF chain, and the second network node may forward the RF measurement result to the first network node.

According to the technical solution, for a terminal with a multi-RF capability, particularly a multi-RF receiving capability, throughput performance of the terminal can be ensured as much as possible on the premise of ensuring measurement accuracy.

Steps 201 and 202 are optional. That is, in an embodiment, the first network node does not need to determine whether RF measurement can be performed on the measurement object by the first RF chain or not, or, even though the first network node can perform RF measurement on the measurement object, RF measurement can also be performed on the measurement object through the second RF chain by steps 203 to 209.

Steps 204 and 205 are also optional. That is, in an embodiment, the second network node does not need to determine whether to accept the measurement request of the first network node or not or provide an option of rejecting the measurement request.

For better understanding the technical solution, an example will be given below.

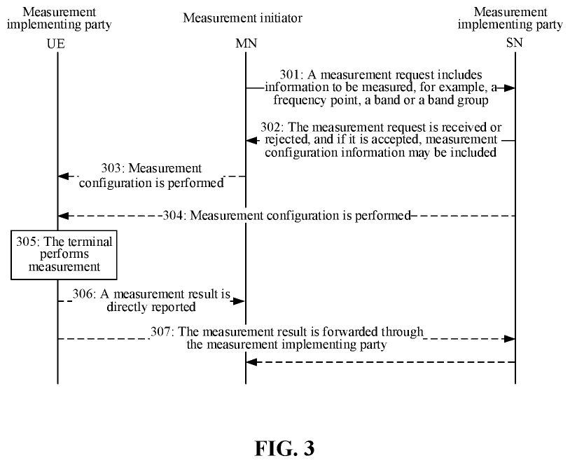

In the scenario shown in FIG. 1, when a measurement initiator (a MN) configures a terminal (UE) to measure a frequency point of a measurement implementing party (a SN), a flow is as shown in FIG. 3. The measurement initiator is the MN (equivalent to the first network node in the above-mentioned technical solution), there are two measurement implementing parties, which are the SN (equivalent to the second network node in the above-mentioned technical solution) that is the measurement implementing party on a network side and the terminal, i.e., the UE that is the other measurement implementing party. In such a case, the required measurement frequency point may be the same as or different from a frequency point that the measurement implementing party originally expects to measure. Of course, the measurement initiator and measurement implementing party on the network side may be exchanged, namely the measurement initiator may be the SN and the measurement implementing party may be the MN, and in such a case, a processing manner is similar.

In step 301, when the network node MN (for example, LTE 2.6 GHz) acting as the measurement initiator determines that the terminal cannot measure the network node SN acting as the implementing party through a corresponding chain (a 2.6 GHz RF chain of an LTE network), the network node acting as the measurement initiator coordinates with the network node acting as the measurement implementing party, for example, the network node acting as the measurement initiator may notify the measurement implementing party of a corresponding measurement object, such as information of a frequency point, through a network-side interface (for example, Xn).

Then, step 302 is executed, namely the measurement implementing party may accept or reject a measurement request; if the measurement implementing party accepts the measurement request, a measurement gap is configured; and if the measurement implementing party rejects the measurement request, a reply is given through the network interface (for example, Xn).

In a case that the measurement implementing party accepts the measurement request and configures a measurement parameter, for example, the measurement gap, the measurement configuration parameter may be sent to the terminal. Sending may be implemented through the measurement implementing party (as shown in step 304), or may be implemented by the measurement initiator (as shown in step 303). During measurement configuration, a correspondence between the measurement gap and measurement object (for example, an identifier of a frequency point, a band or a band group) is required to be configured so as to notify the terminal of the specific frequency point, band or band group that the measurement gap is configured for. Here, the band group may be a combination of all bands that may be covered by an RF chain of the terminal.

In step 305, the terminal performs measurement through an RF chain (for example, a 28 GHz RF chain of an NR network) according to the measurement configuration parameter.

The terminal, after completing measurement, may report the measurement to the measurement initiator directly (shown in step 306), or may report to the measurement initiator after forwarding the measurement report to the measurement implementing party (shown in step 307). During reporting, information of the corresponding frequency point, band or band group is required to be contained.

A second implementation mode of the disclosure relates to a measurement configuration method for a terminal with a multi-RF receiving capability. The implementation mode is an implementation of the first implementation mode on a network side, and related details are the same as those in and may refer to the first implementation mode.

According to the measurement configuration method for a terminal with a multi-RF receiving capability, the terminal is connected with a first network node in a first wireless network through a first RF chain, and the terminal is connected with a second network node in a second wireless network through a second RF chain. The method may include the following steps.

The second network node may receive information of a measurement object from the first network node.

The second network node may generate measurement configuration information according to the information of the measurement object.

The measurement configuration information may be sent to the terminal to implement RF measurement by the second RF chain according to the measurement configuration information. Optionally, the second network node may send the measurement configuration information to the terminal through the second RF chain. Optionally, the second network node may send the measurement configuration information to the first network node, and the first network node may send the measurement configuration information to the terminal through the first RF chain.

The first network node may acquire an RF measurement result of the terminal. Optionally, the first network node may obtain the RF measurement result from the terminal through the first RF chain. Optionally, the second network node may obtain the RF measurement result from the terminal through the second RF chain, and then the second network node may forward the RF measurement result to the first network node.

A third implementation mode of the disclosure relates to a measurement configuration method for a terminal with a multi-RF receiving capability. The implementation mode is an implementation of the first implementation mode on a terminal side, and related details are the same as those in and may refer to the first implementation mode.

According to the measurement configuration method for a terminal with a multi-RF receiving capability, the terminal is connected with a first network node in a first wireless network through a first RF chain, and the terminal is also connected with a second network node in a second wireless network through a second RF chain.

The method may include the following steps.

The terminal may acquire measurement configuration information; the measurement configuration information may be generated by the second network node according to information of a measurement object of the first network node.

The terminal may make RF measurement by the second RF chain according to the measurement configuration information.

The terminal may report an RF measurement result to the first network node. Optionally, the terminal may send the RF measurement result to the first network node through the first RF chain. Optionally, the terminal may send the RF measurement result to the second network node through the second RF chain, and the second network node may forward the RF measurement result to the first network node.

A fourth implementation mode of the disclosure relates to a measurement configuration system for a terminal with a multi-RF receiving capability. The measurement configuration system for the terminal with the multi-RF receiving capability may include a terminal, a first network node in a first wireless network and a second network node in a second wireless network.

The terminal may be connected with the first network node through a first RF chain, and the terminal may be also connected with the second network node through a second RF chain.

The first network node is configured to send information of a measurement object to the second network node and acquire an RF measurement result of the terminal. Optionally, the first network node may obtain the RF measurement result from the terminal through the first RF chain. Optionally, the second network node may obtain the RF measurement result from the terminal through the second RF chain, and then the second network node may forward the RF measurement result to the first network node.

The second network node is configured to generate measurement configuration information according to the information of the measurement object.

The terminal is configured to acquire the measurement configuration information, make RF measurement by the second RF chain according to the measurement configuration information and report the measurement result.

The first implementation mode is a method implementation mode corresponding to the present implementation mode and the present implementation mode may be implemented in combination with the first implementation mode. Related technical details mentioned in the first implementation mode are still effective in the present implementation mode and, for reducing repetitions, will not be elaborated herein. Correspondingly, related technical details mentioned in the present implementation mode may also be applied to the first implementation mode.

A fifth implementation mode of the disclosure relates to a network system. The implementation mode is an implementation of the fourth implementation mode on a network side, and related details are the same as those in and may refer to the fourth implementation mode.

The network system may include a first network node in a first wireless network and a second network node in a second wireless network.

The first network node may be connected with a terminal through a first RF chain, and the second network node may be connected with the terminal through a second RF chain.

The first network node is configured to send information of a measurement object to the second network node and acquire an RF measurement result of the terminal.

The second network node is configured to generate measurement configuration information according to the information of the measurement object and send the generated measurement configuration information to the terminal to make RF measurement by the second RF chain according to the measurement configuration information.

A sixth implementation mode of the disclosure relates to a terminal. The implementation mode is an implementation of the fourth implementation mode on a terminal side, and related details are the same as those in and may refer to the fourth implementation mode.

The terminal may be connected with a first network node in a first wireless network through a first RF chain, and the terminal may be connected with a second network node in a second wireless network through a second RF chain.

The terminal may include:

a module configured to acquire measurement configuration information, the measurement configuration information being generated by the second network node according to information of a measurement object of the first network node;

a module configured to implement RF measurement by the second RF chain according to the measurement configuration information; and

a module configured to report an RF measurement result to the first network node.

A seventh implementation mode of the disclosure relates to a measurement configuration method for a terminal with a multi-RF receiving capability. In the implementation mode, the solution (two wireless networks) in the first implementation mode can be extended to a technical solution involving more wireless networks. The main difference is that the number of wireless networks is different and details about all the other aspects (such as an example of the measurement object, an example of the measurement configuration information and determination about whether to accept the measurement request or not) may refer to the first implementation mode.

According to the measurement configuration method for a terminal with a multi-RF receiving capability, the terminal is connected with a first network node in a first wireless network through a first RF chain, and the terminal is also connected with N network nodes in N different wireless networks through N RF chains respectively, N being a positive integer.

The method may include the following steps.

The first network node may send measurement request messages to the N network nodes respectively, each measurement request message including one piece of measurement object information respectively. Therefore, totally N pieces of measurement object information may be sent to the N network nodes in a one-to-one correspondence manner.

The N other network nodes may generate measurement configuration information according to the received measurement object information respectively; totally N pieces of measurement configuration information may be generated.

The terminal may acquire the N pieces of measurement configuration information. Optionally, all the N network nodes may send the measurement configuration information to the first network node, and the first network node may send the N pieces of measurement configuration information to the terminal through the first RF chain. Optionally, the N network nodes may send the measurement configuration information to the terminal through the RF chains between them and the terminal respectively. Optionally, part of network nodes in the N network nodes may send the measurement configuration information generated by them to the first network node, and the first network node may send the N pieces of measurement configuration information to the terminal through the first RF chain; and the other part of network nodes in the N network nodes may directly send the measurement configuration information generated by them to the terminal through the RF chains between them and the terminal respectively.

The terminal may implement RF measurement by the N RF chains according to the N pieces of measurement configuration information to obtain N RF measurement results.

The first network node may acquire the N RF measurement results. Optionally, the terminal may summarize the N RF measurement results and report them to the first network node through the first RF chain. Optionally, the terminal may report the N RF measurement results to the N network nodes through the N RF chains respectively, and the N network nodes may forward the RF measurement results to the first network node respectively. Optionally, the terminal may select one or more RF chains from the N RF chains connecting with the N network nodes and report the RF measurement results to one or more of the N network nodes through these RF chains, and then each network node receiving the RF measurement results may forward the RF measurement results to the first network node.

An eighth implementation mode of the disclosure relates to a measurement configuration system for a terminal with a multi-RF receiving capability.

The measurement configuration system for a terminal with a multi-RF receiving capability may include a terminal, a first network node in a first wireless network and N network nodes in N wireless networks. The terminal may be connected with the first network node in the first wireless network through a first RF chain, and the terminal may be also connected with the N network nodes in the N different wireless networks through N RF chains respectively, N being a positive integer.

The first network node is configured to send information of a measurement object to the N network nodes and acquire N RF measurement results respectively.

The N network nodes are configured to generate measurement configuration information according to the received information of a measurement object respectively, totally N pieces of measurement configuration information being generated.

The terminal is configured to acquire the N pieces of measurement configuration information and implement RF measurement by the N RF chains according to the N pieces of measurement configuration information to obtain the N RF measurement results.

The seventh implementation mode is a method implementation mode corresponding to the present implementation mode and the present implementation mode may be implemented in combination with the seventh implementation mode. Related technical details mentioned in the seventh implementation mode are also effective in the present implementation mode and, for reducing repetitions, will not be elaborated herein. Correspondingly, related technical details mentioned in the present implementation mode may also be applied to the seventh implementation mode.

According to the first aspect of the embodiments, a measurement configuration method is provided, which includes:

sending, by a first network node, information of a measurement object to a second network node, the information of the measurement object being used for the second network node to generate part of measurement configuration information, the first network node being a master node, and the second network node being a secondary node; and

receiving, by the first network node, a measurement result obtained at the measurement object based on the measurement configuration information from a terminal with a multi-Radio Frequency (RF) receiving capability.

In an embodiment, the measurement configuration information may be received by the terminal through an RF chain for connection between the second network node and the terminal; or, the measurement configuration information, which is sent by the second network node to the first network node, may be received by the terminal through an RF chain for connection between the first network node and the terminal.

In an embodiment, the receiving, by the first network node, the measurement result obtained at the measurement object from the terminal may include:

receiving, by the first network node, the measurement result through an RF chain for connection between the first network node and the terminal; or,

receiving, by the first network node, from the second network node, the measurement result which is sent by the terminal to the second network node through an RF chain for connection between the second network node and the terminal.

In an embodiment, measurement object may be a frequency point, a band or a band group.

In an embodiment, the measurement object may be out of a band range supported by an RF chain connecting the first network node with the terminal.

In an embodiment, the measurement configuration information may include a measurement gap and a correspondence between a measurement gap and a measurement object.

In an embodiment, before sending, by the first network node, the information of the measurement object to the second network node, the method may further include:

determining, by the first network node, whether an RF chain for connection between the first network node and the terminal enables RF measurement to be performed or not; in a case that the RF chain for connection between the first network node and the terminal does not enable RF measurement to be performed, sending the information of the measurement object to the second network node; and in a case that the RF chain for connection between the first network node and the terminal enables RF measurement to be performed, performing RF measurement on the measurement object by the RF chain connecting the first network node with the terminal.

According to a second aspect of the embodiments, a measurement configuration method for a terminal is provided, which includes:

acquiring, by a terminal, measurement configuration information, part of the measurement configuration information being generated by a second network node;

implementing, by the terminal, RF measurement at a measurement object provided by a first network node according to the measurement configuration information; and

reporting, by the terminal, a measurement result to the first network node.

In an embodiment, the implementing, by the terminal, RF measurement at the measurement object provided by the first network node according to the measurement configuration information may include:

implementing, by the terminal, RF measurement on an RF chain for connection between the second network node and the terminal according to the measurement configuration information.

In an embodiment, part of the measurement configuration information may be generated by the second network node based on the information of the measurement object, and the information of the measurement object may be sent by the first network node to the second network node.

In an embodiment, the method may further include:

receiving, by the terminal, the measurement configuration information through an RF chain for connection between the second network node and the terminal; or,

receiving, by the terminal, the measurement configuration information, which is sent by the second network node to the first network node, through an RF chain for connection between the first network node and the terminal.

In an embodiment, the method may further include:

sending the measurement result through an RF chain for connection between the first network node and the terminal; or,

sending the measurement result, through an RF chain for connection between the second network node and the terminal, to the second network node which is configured to forward the measurement result to the first network node.

In an embodiment, the measurement object may be a frequency point, a band or a band group.

In an embodiment, the measurement configuration information may include a measurement gap, and a correspondence between a measurement gap and a measurement object.

According to a third aspect of the embodiments, a terminal is provided, which includes:

a transceiver, and

a processor, which is coupled with the transceiver and configured to control the transceiver to send and receive information;

wherein the terminal has a multi-Radio Frequency (RF) receiving capability, and the processor is configured to:

control the transceiver to acquire measurement configuration information, part of the measurement configuration information being generated by a second network node;

implement Radio Frequency (RF) measurement at a measurement object provided by a first network node according to the measurement configuration information; and

control the transceiver to report a measurement result to the first network node.

In an embodiment, the processor may be further configured to implement RF measurement on an RF chain for connection between the second network node and the terminal according to the measurement configuration information.

In an embodiment, the transceiver may be further configured to:

receive the measurement configuration information through an RF chain for connection between the second network node and the terminal; or,

receive the measurement configuration information, which is sent by the second network node to the first network node, through an RF chain for connection between the first network node and the terminal.

In an embodiment, the transceiver may be further configured to:

send the measurement result through an RF chain for connection between the first network node and the terminal; or,

send the measurement result, through an RF chain for connection between the second network node and the terminal, to the second network node which is configured to forward the measurement result to the first network node.

In an embodiment, the measurement object may be a frequency point, a band or a band group.

In an embodiment, the measurement configuration information may include a measurement gap and a correspondence between a measurement gap and a measurement object.

Each method implementation mode of the disclosure can be implemented through software, hardware, firmware and the like. No matter whether the disclosure is implemented by software, hardware or firmware, instruction codes can be stored in any type of computer-accessible memory (for example, permanent or modifiable, volatile or non-volatile, solid-state or non-solid-state and fixed or removable media). Similarly, the memory may be, for example, a Programmable Array Logic (PAL), a Random Access Memory (RAM), a Programmable Read Only Memory (PROM), a Read-Only Memory (ROM), an Electrically Erasable Programmable ROM (EEPROM), a magnetic disk, an optical disk, a Digital Versatile Disc (DVD) and the like.

It is to be noted that each unit mentioned in each device implementation mode of the disclosure can be a logical unit. Physically, a logical unit can be a physical unit or a part of a physical unit, and can further be implemented by a combination of multiple physical units. A combination of functions implemented by these logical units, rather than Physical implementation modes of these logical units, is the key for solving the technical problem in the disclosure. In addition, for highlighting innovative parts of the disclosure, units not so closely related to the technical problem in the disclosure are not introduced in each device implementation mode of the disclosure, however, it does not mean that no more other units exist in the device implementation mode.

It is to be noted that, in the application document of the patent, a relationship term such as “first” and “second” is adopted to distinguish an entity or operation from another entity or operation only rather than require or imply existence of any practical relationship or sequence between these entities or operations. Moreover, terms “include” and “contain” or any other variant thereof is intended to cover nonexclusive inclusions, so that a process, method, object or device including a series of elements not only includes those elements but also includes other elements which are not clearly listed or further includes elements intrinsic to the process, the method, the object or the device. Under the condition of no more limitations, an element defined by the statement “including a/an” does not exclude existence of the same other elements in a process, method, object or device including the element. In the application document of the patent, execution of an operation according to a certain element refers to execution of the operation at least according to the element, and two conditions are included: execution of the operation only according to the element and execution of the operation according to the element and other elements. Expressions such as “multiple”, “multiple times” and “various” include two, twice, two kinds, more than two, more than twice and more than two kinds.

All documents mentioned in the application are cited as references in the application, just like each document is independently cited as a reference. In addition, it is to be understood that those skilled in the art, after reading the contents of the application, may make various variations or modifications to the application and these equivalent forms shall also fall within the scope claimed by the application.

1. A measurement configuration method, comprising:
sending, by a first network node, information of a measurement object to a second network node, wherein the information of the measurement object is used for the second network node to generate part of measurement configuration information, the first network node is a master node, and the second network node is a secondary node; and
receiving, by the first network node, a measurement result obtained at the measurement object based on the measurement configuration information from a terminal with a multi-Radio Frequency (RF) receiving capability.

2. The measurement configuration method of claim 1, wherein:
the measurement configuration information is received by the terminal through an RF chain for connection between the second network node and the terminal; or,
the measurement configuration information, which is sent by the second network node to the first network node, is received by the terminal through an RF chain for connection between the first network node and the terminal.

3. The measurement configuration method of claim 1, wherein, receiving, by the first network node, the measurement result obtained at the measurement object from the terminal comprises:
receiving, by the first network node, the measurement result through an RF chain for connection between the first network node and the terminal; or,
receiving, by the first network node, from the second network node, the measurement result which is sent by the terminal to the second network node through an RF chain for connection between the second network node and the terminal.

4. The measurement configuration method of claim 1, wherein the measurement object is a frequency point, a band or a band group.

5. The measurement configuration method of claim 1, wherein the measurement object is out of a band range supported by an RF chain connecting the first network node with the terminal.

6. The measurement configuration method of claim 1, wherein the measurement configuration information comprises a measurement gap and a correspondence between a measurement gap and a measurement object.

7. The measurement configuration method of claim 1, before sending, by the first network node, the information of the measurement object to the second network node, the method further comprising:
determining, by the first network node, whether an RF chain for connection between the first network node and the terminal enables RF measurement to be performed or not; in a case that the RF chain for connection between the first network node and the terminal does not enable RF measurement to be performed, sending the information of the measurement object to the second network node; and in a case that the RF chain for connection between the first network node and the terminal enables RF measurement to be performed, performing RF measurement on the measurement object by the RF chain connecting the first network node with the terminal.

8. A measurement configuration method, comprising:
acquiring, by a terminal with a multi-Radio Frequency (RF) receiving capability, measurement configuration information, wherein part of the measurement configuration information is generated by a second network node;
implementing, by the terminal, RF measurement at a measurement object provided by a first network node according to the measurement configuration information; and
reporting, by the terminal, a measurement result to the first network node.

9. The measurement configuration method of claim 8, wherein implementing, by the terminal, RF measurement at the measurement object provided by the first network node according to the measurement configuration information comprises:
implementing, by the terminal, RF measurement on an RF chain for connection between the second network node and the terminal according to the measurement configuration information.

10. The measurement configuration method of claim 8, wherein
part of the measurement configuration information is generated by the second network node based on the information of the measurement object, and the information of the measurement object is sent by the first network node to the second network node.

11. The measurement configuration method of claim 8, further comprising:
receiving, by the terminal, the measurement configuration information through an RF chain for connection between the second network node and the terminal; or,
receiving, by the terminal, the measurement configuration information, which is sent by the second network node to the first network node, through an RF chain for connection between the first network node and the terminal.

12. The measurement configuration method of claim 8, further comprising:
sending the measurement result through an RF chain for connection between the first network node and the terminal; or,
sending the measurement result, through an RF chain for connection between the second network node and the terminal, to the second network node which is configured to forward the measurement result to the first network node.

13. The measurement configuration method of claim 8, wherein the measurement object is a frequency point, a band or a band group.

14. The measurement configuration method of claim 8, wherein the measurement configuration information comprises a measurement gap, and a correspondence between a measurement gap and a measurement object.

15. A terminal, comprising:
a transceiver, and
a processor, which is coupled with the transceiver and configured to control the transceiver to send and receive information;
wherein the terminal has a multi-Radio Frequency (RF) receiving capability, the processor is configured to:
control the transceiver to acquire measurement configuration information, part of the measurement configuration information being generated by a second network node;
implement Radio Frequency (RF) measurement at a measurement object provided by a first network node according to the measurement configuration information; and
control the transceiver to report a measurement result to the first network node.

16. The terminal of claim 15, wherein the processor is further configured to implement RF measurement on an RF chain for connection between the second network node and the terminal according to the measurement configuration information.

17. The terminal of claim 15, wherein the transceiver is further configured to:
receive the measurement configuration information through an RF chain for connection between the second network node and the terminal; or,
receive the measurement configuration information, which is sent by the second network node to the first network node, through an RF chain for connection between the first network node and the terminal.

18. The terminal of claim 15, wherein the transceiver is further configured to:
send the measurement result through an RF chain for connection between the first network node and the terminal; or,
send the measurement result, through an RF chain for connection between the second network node and the terminal, to the second network node which is configured to forward the measurement result to the first network node.

19. The terminal of claim 15, wherein the measurement object is a frequency point, a band or a band group.

20. The terminal of claim 15, wherein the measurement configuration information comprises a measurement gap, and a correspondence between a measurement gap and a measurement object.
